(19) United States
(12) Patent Application Publication
(10) Pub. No.: US 2003/0021421 A1
(43) Pub. Date: Jan. 30, 2003

(54) Method of producing a decrypting apparatus having a cryptographic device and cryptographic information, a system for providing such device and information, and the decrypting apparatus produced by the production method

(76) Inventors: Kaoru Yokota, Ashiya (JP); Taihei Yugawa, Nara (JP); Shinji Inoue, Neyagawa (JP)

Correspondence Address: WENDEROTH, LIND & PONACK, L.L.P., 2033 K STREET N. W., SUITE 800, WASHINGTON, DC, 20006-1021, US

(21) Appl. No.: 10/196,410

(22) Filed: Jul. 17, 2002

(30) Foreign Application Priority Data
Jul. 25, 2001 (JP) 2001-224126

(51) Int. Cl. H04L 9/00

(52) U.S. Cl. 380/277

(57) ABSTRACT

The main disclosure of the present invention is a method of producing a decrypting apparatus that includes a cryptographic device and a decryption key. Using the production method, the decryption key is confidentially acquired under a security-controlled condition, and conversion information is generated, the conversion information including encrypted decryption key which has been obtained by encrypting the acquired decryption key using an encryption method. Then, the conversion information is written in a nonvolatile memory which is to be incorporated in the decryption apparatus, and the decryption apparatus is assembled to include the cryptographic device in which a first circuit and a second circuit have been integrated, the first circuit decrypting the conversion information, and the second circuit performing decryption using the decryption key.

### BACKGROUND OF THE INVENTION

(1) Field of the Invention

The present invention relates to a method of producing a decrypting apparatus that has a cryptographic device and cryptographic information, the decrypting apparatus being such as an AV digital apparatus that has a function for protecting a copyright. The present invention also relates to a providing system of such device and information, and further to a decryption apparatus produced by the production method.

(2) Related Art

In recent years, as more and more AV contents including movies or music are being digitalized, various services are made possible, such as distribution services of pay contents such as movies or music and digital broadcasting directed to a certain audience. To realize such services, an cryptographic technology is necessary for preventing unauthorized access to AV contents. Accordingly, in distributing AV contents either by a recording medium or through the Internet or via a broadcasting network, the AV contents are encrypted in advance. It is the system that only users or audiences that paid the charge can exclusively decrypt the AV contents for the purpose of reproducing.

Reproducing apparatuses used in the mentioned system have to have a cryptographic circuit and key information so as to perform cryptographic operations relating to decryption of encrypted contents. Accordingly, the production of such reproducing apparatuses necessitates a process for producing a cryptographic circuit and writing of key information, in addition to a process for producing an AV decoder.

FIG. 1 shows a construction of a pay contents distribution that uses a recording medium.

A pay contents recording medium 15 is an optical disc, for example, that has a large capacity for storing digital contents data. The pay contents recording medium 15 includes: an encrypted contents key data storage area 17 for storing encrypted contents key data; and an encrypted contents data storage area 18 for storing encrypted contents data. The encrypted contents key data is obtained by encrypting contents key data using apparatus unique secret information that is unique to a reproducing apparatus of a user who purchased the content, and the encrypted contents data is obtained by encrypting contents data using contents key data. A pay contents reproduction apparatus 16 is for reproducing pay contents stored in the pay contents recording medium 15, and includes: a nonvolatile memory 19 for storing apparatus unique secret information used for cryptographic operations; and cryptographic LSI 20 that performs such cryptographic operations. The apparatus unique secret information is to be supplied to each reproduction apparatus as a unique information. The following operations are performed by the pay contents reproduction apparatus 16 for reproducing pay contents data stored in the pay contents recording medium 15.

First, the cryptographic LSI 20 reads encrypted contents key data from the encrypted contents key data storage area 17, and encrypted contents data from the encrypted contents data storage area 18. Then, the cryptographic LSI 20 decrypts the encrypted contents data through a series of decrypting operations using apparatus unique secret information stored in the nonvolatile memory 19.

For decrypting an encrypted content in the pay contents reproduction apparatus 16, it is required to use the apparatus unique secret information so as to firstly decrypt the encrypted contents key data. Therefore, only the pay contents reproduction apparatus 16 of this user can reproduce the pay content, which prevents unauthorized reproduction by others.

FIG. 2 shows a construction of pay contents distribution through the internet or via a broadcasting network.

In FIG. 1 example, the encrypted contents key data and the encrypted contents data are both read from the pay contents recording medium 15. In FIG. 2 example, these two pieces of data are transmitted from a pay contents distributing unit 23 of a pay contents distributing station 21 and reaches the pay contents reproduction apparatus 22 through a communication path. The pay contents distributing station 21 is a contents provider if the distribution is through the Internet, and a broadcast station if the distribution is through a broadcasting network. Further, in FIG. 2, a pay contents reproduction apparatus 22 is a personal computer or a digital set top box that reproduces a pay content which the user has purchased and received. The operation performed after receiving the key data and the contents data is the same as that performed by the pay contents reproduction apparatus 16 of FIG. 1.

FIG. 3 shows an internal construction of cryptographic LSI 25 which is included in the pay contents reproduction apparatus 22 of FIG. 2. The cryptographic LSI 25 includes a contents key decrypting circuit 251, and a contents decrypting circuit 252.

The following describes the operation performed by the cryptographic LSI 25, with reference to FIG. 3. First, the contents key decrypting circuit 251 decrypts encrypted contents key data inputted from outside so as to obtain a contents key, by the use of apparatus unique secret information read from the nonvolatile memory 24. Then, the contents decrypting circuit 252 decrypts encrypted contents data inputted from outside, using this contents key.

FIG. 4 shows a conventional method of producing a pay contents reproduction apparatus that is equipped with a nonvolatile memory and cryptographic LSI.

The secret information issuing unit 26 is run by a license organization that permits, to an apparatus production unit 27, the use of cryptographic technology on pay contents reproduction apparatuses. Apparatus unique secret information issued by the secret information issuing unit 26 is confidentially sent to an apparatus production unit 27 which is permitted the production of the reproduction apparatuses. The apparatus production unit 27 in FIG. 4 includes an assembly unit 271 and a LSI production unit 272. The assembly unit 271 writes the received apparatus unique secret information to the nonvolatile memory 24.

This nonvolatile memory 24 and the cryptographic LSI 25 produced at the LSI production unit 272 are assembled into a pay contents reproduction apparatus. Note that in the pay contents reproduction apparatus, other components are also included such as a circuit for decoding AV contents data and the like. However the description thereof is omitted here since these components are not directly relevant to the present invention.

It is important for the apparatus unique secret information to be kept confidential after issued until assembled into a product. In order to maintain the confidentiality, a work space at the assembly unit 271 has to have a lockable door and surrounding walls, in which only authorized workers can pursue the operations.

However, such arrangement for the work space is costly, and the number of workers that can work there will be limited, which decreases productivity. In addition, one company usually have several factories for the production of several models. Therefore every factory has to have such an extraordinary work space in an assembly unit, which even more increases cost for the company.

### SUMMARY OF THE INVENTION

The object of the present invention, in order to prevent the increase in cost incurred for setting up a special environment and the decrease in productivity, is to provide a method of producing a pay contents reproduction apparatus that includes apparatus unique secret information, and to provide a system for providing the pay contents reproduction apparatus that has apparatus unique information and LSI. Another object of the present invention is to provide the pay contents reproduction apparatus produced by the production method.

The above mentioned object is achieved by a method of producing a decryption apparatus that performs decryption using a decryption key, including: an acquiring step for confidentially acquiring the decryption key under a security-controlled condition; a conversion information outputting step for generating conversion information, under the security-controlled condition, that includes an encrypted decryption key generated by encrypting the decryption key using an encryption method, and for outputting the generated conversion information; a writing step for writing the outputted conversion information to a nonvolatile memory which is to be incorporated in the decryption apparatus; and an assembling step for assembling the decryption apparatus to incorporate therein an integrated device, the integrated device including a first circuit and a second circuit, the first circuit decrypting the encrypted decryption key using a decryption method that corresponds to the encryption method, and the second circuit performing decryption using the decryption key.

According to the above construction, an encrypted decryption key is used in the writing and assembling steps, not using the decryption key as it is. Therefore, it becomes unnecessary to execute these steps in a security-controlled space. Moreover, after decrypting the encrypted decryption key inside the integrated device, the resulting decryption key will not be taken outside the integrated device, which facilitates maintaining confidentiality.

The above construction can provide a production method that can prevent increase in cost for setting up a special environment for executing the writing and assembling steps, in order to keep confidentiality of the decryption key. The above construction also enables to prevent decrease in productivity due to limiting a number of workers who are allowed to pursue the mentioned steps.

Here, the writing step may be executed under another condition where a lower level of security is retained than the security-controlled condition.

The differentiation between a condition that requires high confidentiality and a condition that does not help realize a production method that does not increase in cost for setting up a special environment for the assembly unit for controlling confidentiality. Moreover, the above construction does not decrease in productivity due to limiting a number of workers who are allowed in the special environment.

Here, the encryption method may be a secret key cryptographic method that is executed using a secret key, and the conversion information outputting step may encrypt the decryption key using a secret key that has a fixed value.

According to the construction, the adoption of the secret key cryptographic method yields a simplified operation for both of encryption and decryption, compared to when the public key cryptographic method is adopted.

Here, the conversion information outputting step may include: a selection substep for selecting the encryption method from a plurality of encryption methods; a selection information generating substep for generating selection information that identifies the encryption method which has been selected at the selection substep; an encryption substep for encrypting the decryption key using the encryption method to generate the encrypted decryption key; and a conversion information generating substep for generating the conversion information that includes the encrypted decryption key and the selection information, and the integrated device may further include a third circuit that identifies the encryption method according to the selection information.

According to the construction, the decryption key will be encrypted using one of the plurality of encryption methods.

This enhances the confidentiality of the decryption key, compared to when there is only one encryption method available.

Moreover, the construction enables to write, in the nonvolatile memory, the selection information included in the conversion information. Therefore, the integrated device is able to identify the encryption method that has been used for encrypting the decryption key.

Here, the encryption method may be a secret key cryptographic method that is executed using a secret key, the selection substep may select the secret key from a plurality of secret keys, the selection information generating substep may generate the selection information that identifies the secret key which has been selected at the selection substep, the encryption substep may encrypt the decryption key using the secret key to generate the encrypted decryption key, the conversion information generating substep may generate the conversion information that includes the encrypted decryption key generated at the encryption substep and the selection information that identifies the secret key, and the third circuit may identify the secret key according to the selection information.

According to the construction, the adoption of the secret key cryptographic method yields a simplified operation for both of encryption and decryption, compared to when the public key cryptographic method is adopted.

Moreover, the construction enables to write, in the nonvolatile memory, the selection information included in the conversion information. Therefore, the integrated device is able to identify the encryption method that has been used for encrypting the decryption key.

Here, the conversion information outputting step may further include a key generating substep for generating the plurality of secret keys, and the selection substep may select the secret key from the plurality of secret keys that have been generated at the key generating substep.

According to the construction, a plurality of secret keys can be generated. The fact that more than one secret key is available enhances the confidentiality of the decryption key.

Here, the acquiring step may acquire the decryption key that is unique to the decryption apparatus.

According to the construction, a different decryption key can be assigned to each decryption apparatus. The construction further enables to correspond decryption apparatuses and decryption keys in one-to-one relationship.

Here, the providing system that can achieve the above object is a providing system including an information providing apparatus that provides information to be incorporated in the decryption apparatus, and an integrated-device providing apparatus that provides an integrated device to be incorporated in the decryption apparatus, the information providing apparatus being placed under a security-controlled condition and including: an acquiring unit for confidentially acquiring a decryption key which is used in the decryption apparatus for performing decryption; and a conversion information outputting unit for generating conversion information that includes an encrypted decryption key generated by encrypting the acquired decryption key using an encryption method, and for outputting the generated conversion information to an assembly unit, the assembly unit being to assemble the decryption apparatus, and the integrated-device providing apparatus including: a producing unit for producing an integrated device that includes a first circuit and a second circuit, the first circuit decrypting the encrypted decryption key using a decryption method that corresponds to the encryption method, and the second circuit performing decryption using the decryption key; and an integrated-device providing unit for providing the assembly unit with the integrated device produced by the producing unit.

According to the construction, the information providing apparatus is placed under a security-controlled condition, for encrypting the decryption key to generate the encrypted decryption key. The encrypted decryption key is then included in the conversion information and provided to the assembly unit.

As a result, a providing system will be possible that does not incur cost for setting up a special environment, and that does not decrease the productivity since a number of workers who can work therefor will not be limited.

Here, in the providing system, the encryption method may be a secret key cryptographic method that is executed using a secret key, and the conversion information outputting unit may encrypt the decryption key using a secret key that has a fixed value.

According to the construction, the adoption of the secret key cryptographic method yields a simplified operation for both of encryption and decryption, compared to when the public key cryptographic method is adopted.

Here, in the providing system, the conversion information outputting unit may include: a selection unit for selecting the encryption method from a plurality of encryption methods; a selection information generating unit for generating selection information that identifies the encryption method which has been selected at the selection unit; an encryption unit for encrypting the decryption key using the encryption method to generate the encrypted decryption key; and a conversion information generating unit for generating the conversion information that includes the encrypted decryption key and the selection information, and the integrated device may further include a third circuit that identifies the encryption method according to the selection information.

According to the construction, the decryption key will be encrypted using one of the plurality of encryption methods.

This enhances the confidentiality of the decryption key, compared to when there is only one encryption method available.

Moreover, the construction enables to write, in the nonvolatile memory, the selection information included in the conversion information. Therefore, the integrated device is able to identify the encryption method that has been used for encrypting the decryption key.

Here, in the providing system, the encryption method may be a secret key cryptographic method that is executed using a secret key, the selection unit may select the secret key from a plurality of secret keys, the selection information generating unit may generate selection information that identifies the secret key which has been selected by the selection unit, the encryption unit may encrypt the decryption key using the secret key to generate the encrypted decryption key, the conversion information generating unit may generate the conversion information that includes the encrypted decryption key generated by the encryption unit and the selection information that identifies the secret key, and the third circuit may identify the secret key according to the selection information.

According to the construction, the adoption of the secret key cryptographic method yields a simplified operation for both of encryption and decryption, compared to when the public key cryptographic method is adopted.

Moreover, the construction enables to write, in the nonvolatile memory, the selection information included in the conversion information. Therefore, the integrated device is able to identify the encryption method that has been used for encrypting the decryption key.

Here, in the providing system, the conversion information outputting unit may further include a key generating unit for generating the plurality of secret keys, and the selection unit may select the secret key from the plurality of secret keys that have been generated by the key generating unit.

According to the construction, a plurality of secret keys can be generated. The fact that more than one secret key is available enhances the confidentiality of the decryption key.

Here, in the providing system, the acquiring unit may acquire the decryption key that is unique to the decryption apparatus.

According to the construction, a different decryption key can be assigned to each decryption apparatus. The construction further enables to correspond decryption apparatuses and decryption keys in one-to-one relationship.

Furthermore, the decryption apparatus that can achieve the above object is a decryption apparatus that performs decryption using a decryption key, including: a nonvolatile memory that stores conversion information that includes encrypted decryption key generated by encrypting the decryption key using an encryption method; and an integrated device that includes a first circuit and a second circuit, the first circuit decrypting the encrypted decryption key using a decryption method that corresponds to the encryption method, and the second circuit performing decryption using the decryption key.

According to the above construction, an encrypted decryption key is used in the writing and assembling steps, not using the decryption key as it is. Therefore, it becomes unnecessary to execute these steps in a security-controlled space. Moreover, after decrypting the encrypted decryption key inside the integrated device, the resulting decryption key will not be taken outside the integrated device, which facilitates maintaining confidentiality.

Therefore, a production method will be provided which does not increase in cost for setting up a special environment for the assembly unit for controlling confidentiality, and which does not decrease in productivity due to limiting a number of workers who are allowed in the special environment.

Here, in the decryption apparatus, the encryption method may be a secret key cryptographic method that is executed using a secret key, the nonvolatile memory may store the conversion information that includes encrypted decryption key generated by encrypting the decryption key using a secret key that has a fixed value, and the integrated device may include the first circuit which decrypts the encrypted decryption key using the secret key that has the fixed value.

According to the construction, the adoption of the secret key cryptographic method yields a simplified operation for both of encryption and decryption, compared to when the public key cryptographic method is adopted.

Here, in the decryption apparatus, the encryption method may be selected from a plurality of encryption methods, the nonvolatile memory may store the conversion information that includes selection information identifying the selected encryption method and the encrypted decryption key; and the integrated device may further include a third circuit that identifies the encryption method according to the selection information.

According to the construction, the decryption key will be encrypted using one of the plurality of encryption methods.

This enhances the confidentiality of the decryption key, compared to when there is only one encryption method available.

Moreover, the construction enables to write, in the nonvolatile memory, the selection information included in the conversion information. Therefore, the integrated device is able to identify the encryption method that has been used for encrypting the decryption key.

Here, in the decryption apparatus, the encryption method may be a secret key cryptographic method that is executed using a secret key, the secret key being selected from a plurality of secret keys, the nonvolatile memory may store the conversion information that includes the selection information identifying the selected secret key and the encrypted decryption key, and the integrated device may include the third circuit that identifies the secret key according to the selection information.

According to the construction, the adoption of the secret key cryptographic method yields a simplified operation for both of encryption and decryption, compared to when the public key cryptographic method is adopted.

Moreover, the construction enables to write, in the nonvolatile memory, the selection information included in the conversion information. Therefore, the integrated device is able to identify the encryption method that has been used for encrypting the decryption key.

Here, in the decryption apparatus, the nonvolatile memory may store thereon the conversion information that includes the encrypted decryption key generated by encrypting, using the encryption method, the decryption key which is unique to the decryption apparatus.

According to the construction, a different decryption key can be assigned to each decryption apparatus. The construction further enables to correspond decryption apparatuses and decryption keys in one-to-one relationship.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 shows a construction of pay contents distribution that uses a recording medium;

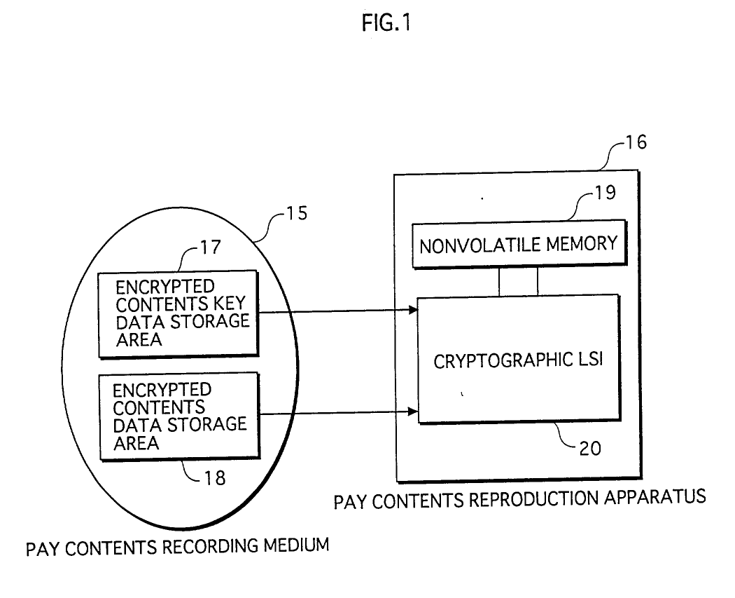

FIG. 2 shows a construction of pay contents distribution that uses the Internet or via a broadcasting network;

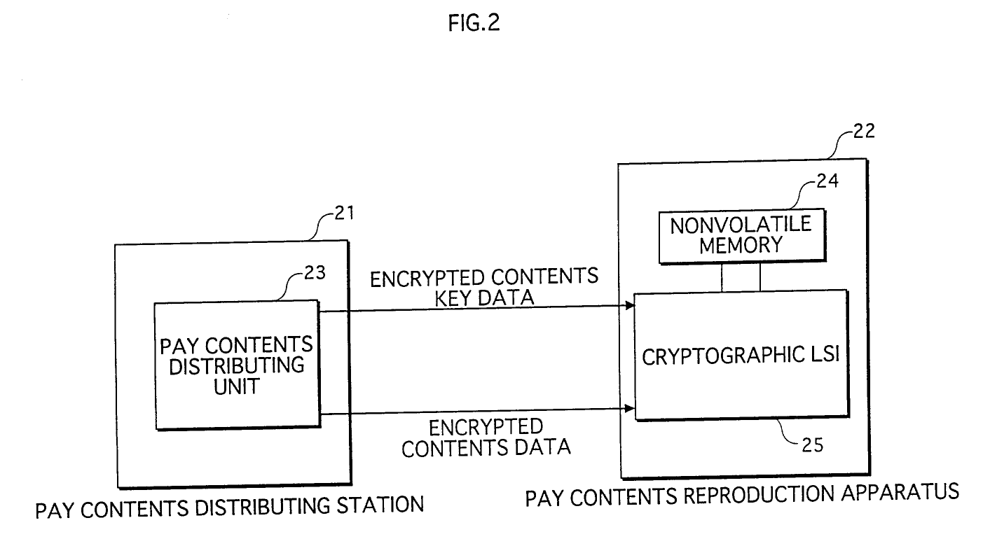

FIG. 3 shows an internal construction of cryptographic LSI 25;

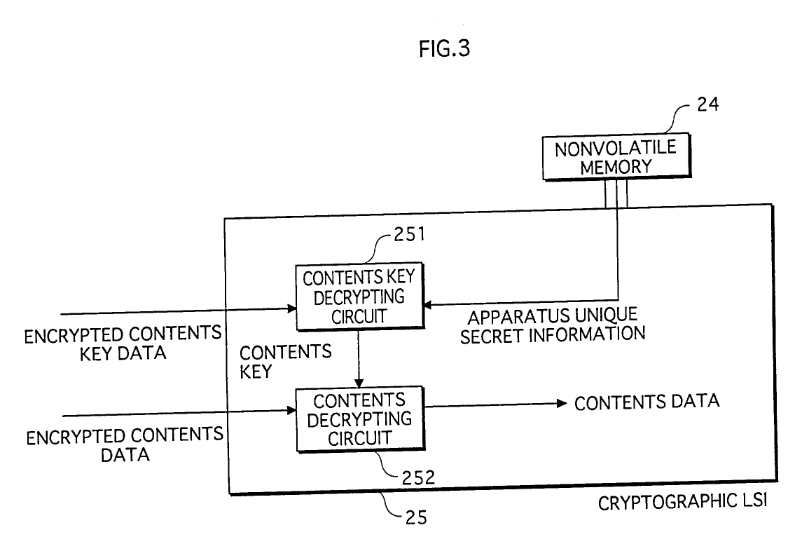

FIG. 4 shows a conventional method of producing a pay contents reproduction apparatus that is equipped with a nonvolatile memory and cryptographic LSI;

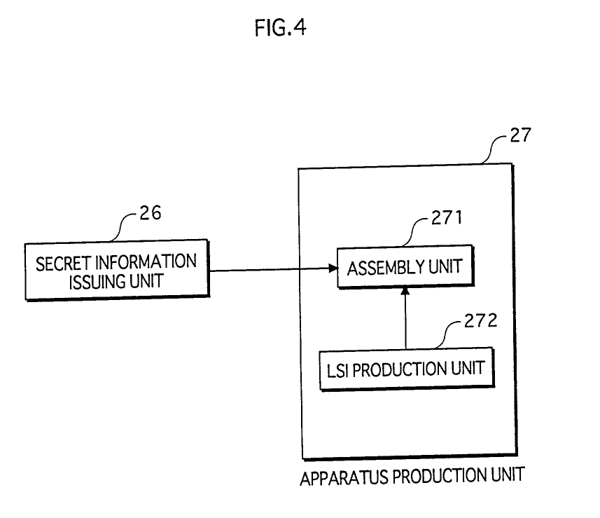

FIG. 5 shows a construction of a method of producing a pay contents reproduction apparatus that includes apparatus unique secret information, which is the first embodiment of the present invention;

FIG. 6 shows constructions of a nonvolatile memory 6 and cryptographic LSI 7 which are for reproducing pay contents;

FIG. 7 shows a method of producing a pay contents reproduction apparatus that has its own apparatus unique secret information, according to the present invention;

FIG. 8 shows a construction of a method of producing a pay contents reproduction apparatus that includes apparatus unique secret information, which is the second embodiment relating to the present invention;

FIG. 9 shows a construction of a nonvolatile memory and cryptographic LSI which are for reproducing pay contents; and

FIG. 10 shows a method of producing a pay contents reproduction apparatus that includes apparatus unique secret information, which relates to the second embodiment of the present invention.

### DESCRIPTION OF THE PREFERRED EMBODIMENTS

(Embodiment 1)

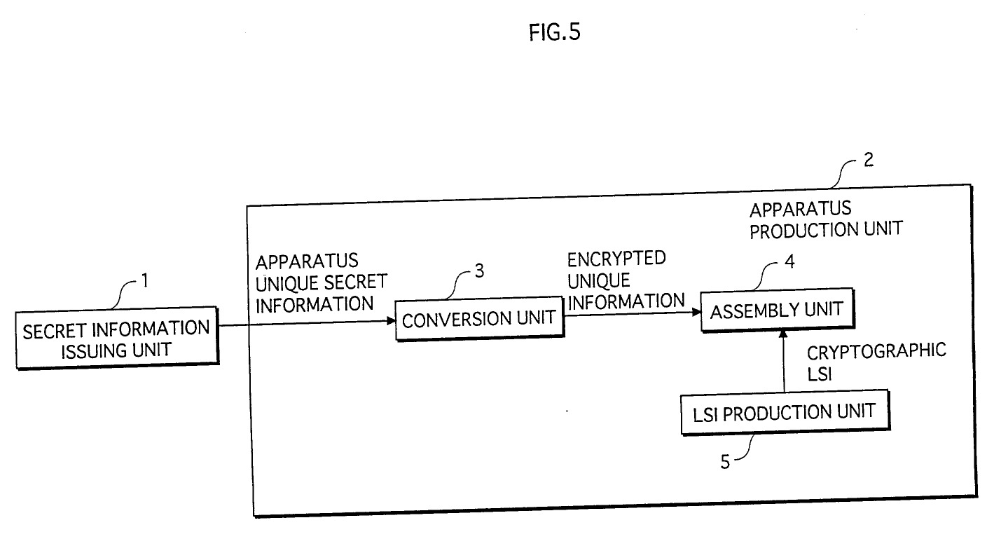

FIG. 5 shows a construction of a method of producing a pay contents reproduction apparatus that includes apparatus unique secret information, which is the first embodiment of the present invention.

A secret information issuing unit 1 issues apparatus unique secret information that is unique to an apparatus production unit 2 which is permitted to produce pay contents reproduction apparatuses, and sends the information to the apparatus production unit 2.

The apparatus production unit 2 includes a conversion unit 3, an assembly unit 4, and a LSI production unit 5, and produces a pay contents reproduction apparatus that includes its own apparatus unique secret information.

The conversion unit 3 encrypts the apparatus unique secret information to generate encrypted unique information, in a work space where the security is controlled. The generated encrypted unique information is then sent to the assembly unit 4.

Here, the work space where the security is controlled may be realized, for example, by isolating the place by a lockable door and with walls. Such work space assures the confidentiality of the operation performed therein. And the certain encryption is, for example, Data Encryption Standard (DES) that uses a secret key of 64 bits (including parity bit of 8 bits). For detailed explanation of DES, please refer to “Introduction to Cryptography Theory” by Eiji OKAMOTO (Kyoritsu Shuppan Co. Ltd.).

The assembly unit 4 writes the received encrypted unique information to a nonvolatile memory, and assembles cryptographic LSI produced at the LSI production unit 5, and so on, into a pay contents reproduction apparatus.

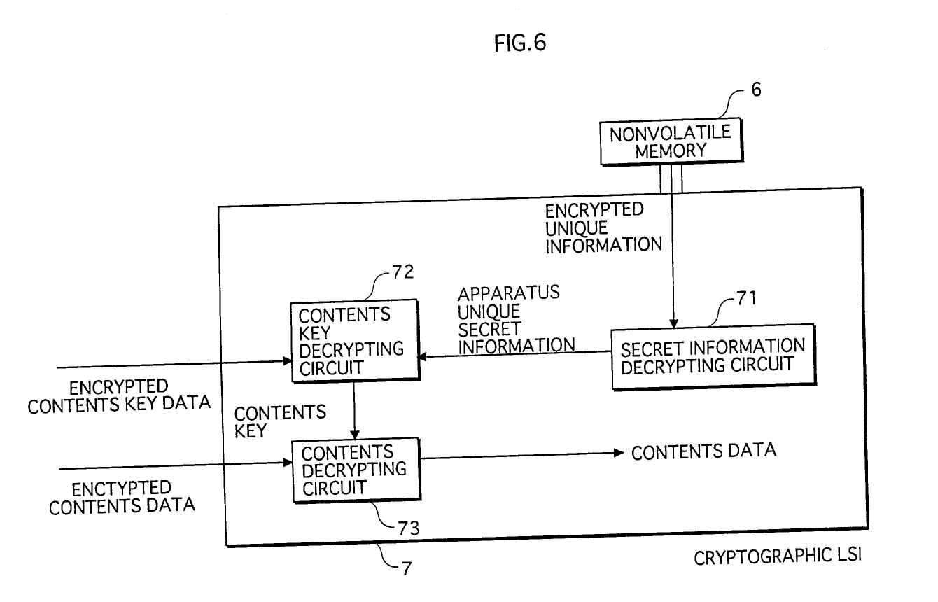

FIG. 6 shows constructions of a nonvolatile memory 6 and cryptographic LSI 7, which are for reproducing pay contents.

In the assembly unit, the encrypted unique information is written on the nonvolatile memory 6, and a pay contents reproduction apparatus is assembled to include cryptographic LSI 7.

The cryptographic LSI 7, being produced at the LSI production unit 5, includes a secret information decrypting circuit 71, a contents key decrypting circuit 72, and a contents decrypting circuit 73. The cryptographic LSI 7 receives encrypted content key data and decrypts the key data into a content key using the apparatus unique secret information as a decryption key, and further decrypts the encrypted contents data using the contents key.

The secret information decrypting circuit 71 decrypts the encryption performed, at the conversion unit 3, on the apparatus unique secret information. By doing so, the encrypted unique information is decrypted into apparatus unique secret information. Specifically, the decryption uses a DES decrypting method using a secret key of 64 bits (including parity 8 bits) which is the same key used in encryption at the conversion unit 3.

The contents key decrypting circuit 72 decrypts encrypted contents key data inputted from outside, using the apparatus unique secret information obtained at the secret information decrypting circuit 71.

The contents decrypting circuit 73 decrypts encrypted contents data inputted from outside, by the use of the decrypted contents key obtained at the contents key decrypting circuit 72.

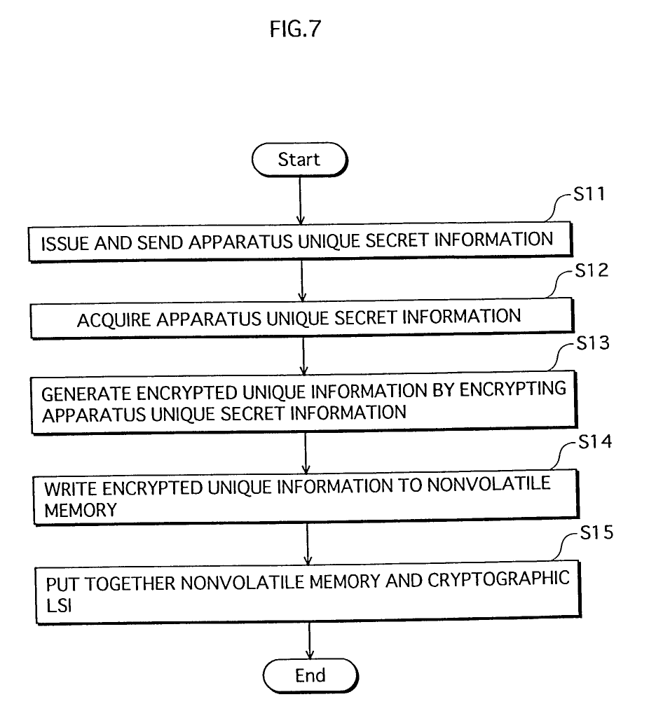

FIG. 7 shows a method of producing the pay contents reproduction apparatus that has its own apparatus unique secret information, relating to the present invention.

The following is a description on the procedure of producing the pay contents reproduction apparatus which is the first embodiment.

The secret information issuing unit 1 issues apparatus unique secret information, and sends the information to the apparatus production unit 2 that is permitted to produce apparatuses (Step S11).

The conversion unit 3 confidentially acquires the sent apparatus unique secret information at a place where the security is controlled (Step S12), and performs encryption on the apparatus unique secret information to generate encrypted unique information(Step S13). The generated encrypted unique information is then sent to the assembly unit 4.

The assembly unit 4 writes the received encrypted unique information to the nonvolatile memory (Step S14), and assembles the cryptographic LSI and the like (Step S15), into a pay contents reproduction apparatus.

In the first embodiment, the encrypted unique information obtained at the conversion unit 3 is decrypted into the apparatus unique secret information. The apparatus unique secret information is then inputted to the contents key decrypting circuit 72. As such, the decryption of the encrypted contents key data is performed using information that is identical to the apparatus unique secret information issued at the secret information issuing unit 1, which ensures a proper operation of the following contents decryption.

In addition, the apparatus unique secret information is sent to the assembly unit 4 as encrypted unique information. Since the encrypted unique information is data after having been subjected to encryption, which does not require special attention to keep confidentiality. This further means that the assembly unit 4 does not require to have a special environment in which confidentiality is strictly maintained for pursuing such operation as writing in the nonvolatile memory and as assembling, which neither incurs the set up cost for the special environment at the assembly unit 4 nor decreases productivity of the work pursued therein.

(Embodiment 2)

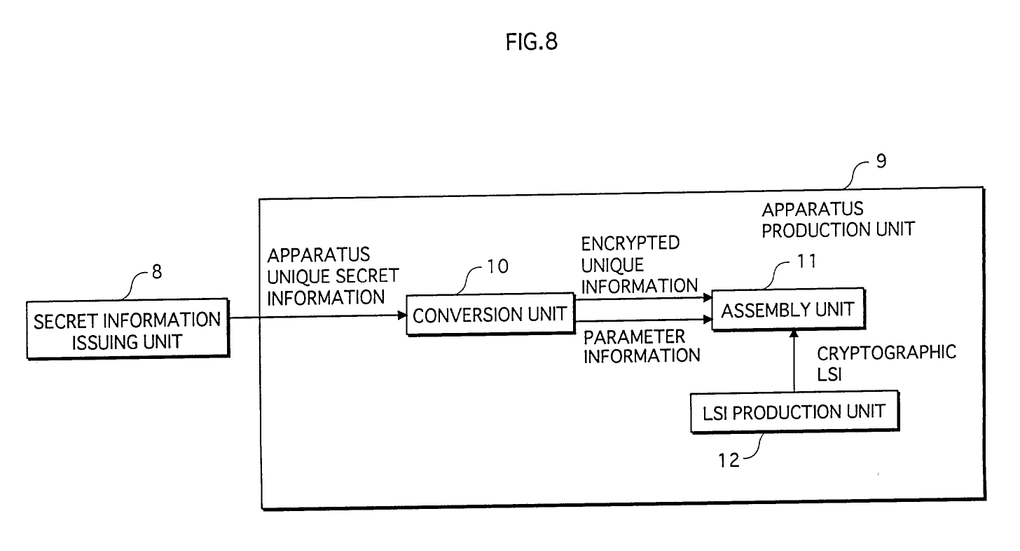

FIG. 8 shows a construction of a method of producing a pay contents reproduction apparatus that includes apparatus unique secret information, which is the second embodiment relating to the present invention.

The second embodiment is different from the first embodiment in that the encryption used at the conversion unit 10 is selected from a plurality of encryption methods. The description is focused on this point.

A secret information issuing unit 8 sends apparatus unique secret information to an apparatus production unit 9. The apparatus production unit 9 includes a conversion unit 10, an assembly unit 11, and a LSI production unit 12.

The conversion unit 10 encrypts apparatus unique secret information, in a work space where the security is controlled, using one of a plurality of encryption methods to generate encrypted unique information. Then, the conversion unit 10 sends parameter information showing which encryption method has been selected together with the generated encrypted unique information to the assembly unit 11. To be more detailed, the encryption method is selected among 16 kinds of 64-bit secret keys that are in accordance with the DES cryptography. The 16 secret keys are assigned a number from 1-16, each piece of parameter information is represented by each number 1-16.

The assembly unit 11 writes the encrypted unique information and the parameter information that have been sent from the conversion unit 11, and assembles the cryptographic LSI produced at the LSI production unit 12 and the like, into a pay contents reproduction apparatus.

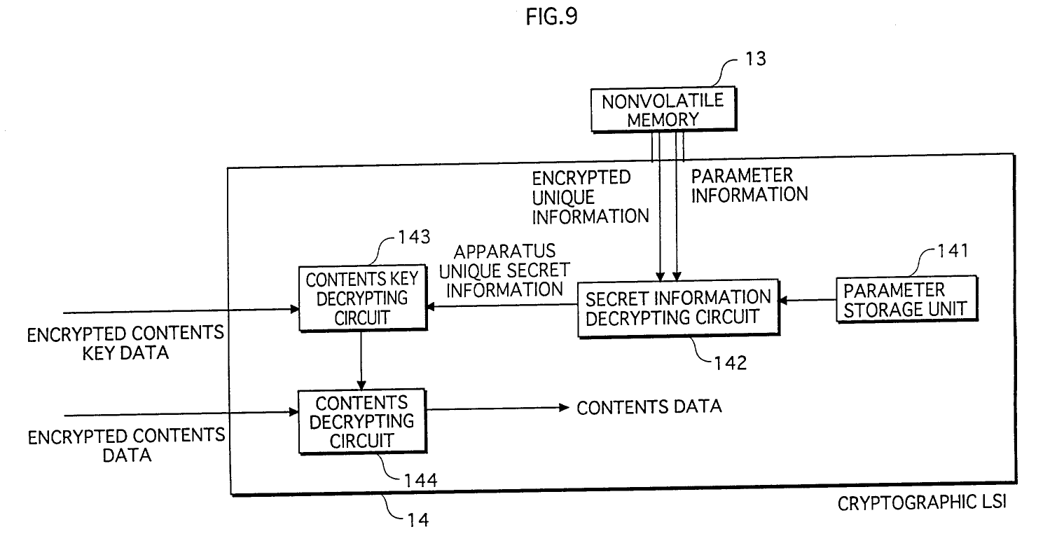

FIG. 9 shows a construction of the nonvolatile memory and the cryptographic LSI which are for reproducing pay contents.

A nonvolatile memory 13 includes encrypted unique information and parameter information are written thereon, and is assembled into the pay contents reproduction apparatus by being connected to the cryptographic LSI 14.

The cryptographic LSI 14 has been produced at the LSI production unit 12, and includes a parameter storage unit 141, a secret information decrypting circuit 142, a contents key decrypting circuit 143, and a contents decrypting circuit 144.

The parameter storage unit 141 stores thereon parameter information that corresponds to each of the 16 encryption methods stored in the conversion unit 10. Concretely, each piece of parameter information represents a decryption method that corresponds to each of the 16 secret keys. Each piece of the parameter information here is also assigned number 1-16.

The secret information decrypting circuit 142 reads the encrypted unique information and the parameter information from the nonvolatile memory 13, and decrypts the encrypted unique information into apparatus unique secret information using a decryption method chosen based on the parameter information.

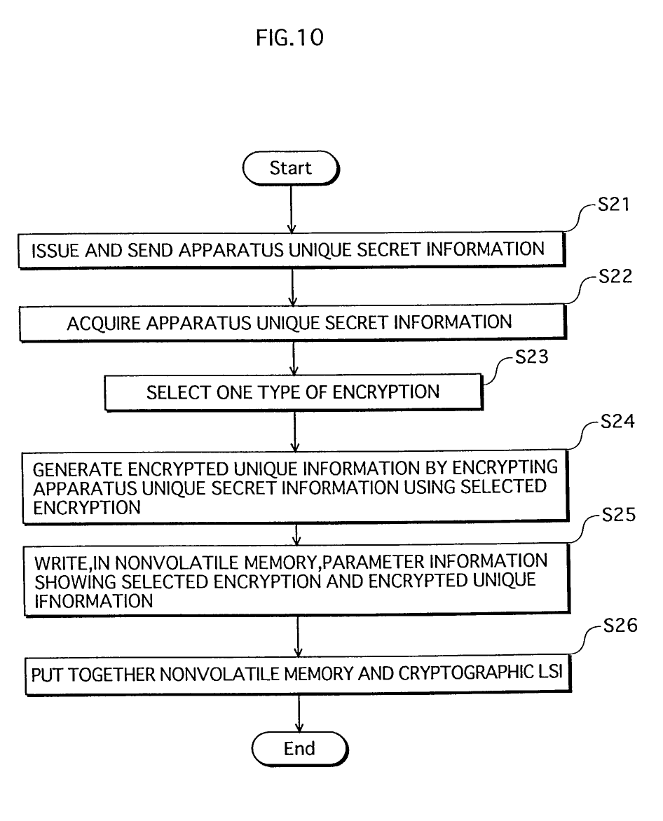

FIG. 10 shows a method of producing a pay contents reproduction apparatus that includes apparatus unique secret information, which relates to the second embodiment of the present invention.

The following describes the production method according to the second embodiment with reference to FIG. 10.

The secret information issuing unit 8 issues apparatus unique secret information, and sends the information to the apparatus production unit 9 that is permitted to produce the apparatuses (Step S21).

The conversion unit 10 confidentially acquires the apparatus unique secret information that has been sent thereto, at a place where security is controlled (Step S22). Then, the conversion unit 10 selects one of the plurality of encryption methods (Step S23), and encrypts the apparatus unique secret information using the selected encryption method, so as to generate encrypted unique information (Step S24). Finally, the conversion unit 10 sends parameter information identifying the selected encryption method together with the generated encrypted unique information to the assembly unit 11.

The assembly unit 11 writes, in the nonvolatile memory 13, the parameter information and the encrypted unique information which have been sent from the conversion unit 10 (StepS25). The assembly unit 11 then assembles the cryptographic LSI produced at the LSI production unit 12 (Step S26) into a pay contents reproduction apparatus.

In the second embodiment, just as the first embodiment, apparatus unique secret information that requires confidentiality is first converted into encrypted unique information before being sent to the assembly unit 11. This makes it unnecessary to set up a special environment for ensuring confidentiality at the assembly unit 11, which neither incurs the cost for such a special environment nor decreases productivity. In fact, the second embodiment enables to select an encryption method for encrypting apparatus unique secret information. This made it possible to generate, from one piece of apparatus unique secret information, a different piece of encrypted unique information by selecting a different encryption method. This makes the second embodiment to achieve enhanced confidentiality of the apparatus unique secret information, when compared to the first embodiment.

Note that at the conversion unit 3 in the first embodiment, the encryption is realized by a DES encryption method using a secret key of 64 bits, and the corresponding decryption is realized by a DES decryption using the same fixed key. However, the cryptographic methods can be any method as long as that can realize encryption and corresponding decryption.

Likewise, in the second embodiment, the conversion unit 10 adopts a DES cryptography using 16 kinds of secret keys that each have 64 bit length. However, the cryptographic methods can be anything that can realize encryption and corresponding decryption, and the number of secret keys is not limited to 16, and can be any number.

Further, in the second embodiment, the plurality of encryption methods use a conversion method in accordance with the DES cryptography having 16 kinds of secret keys. These 16 kinds of secret keys can be different for each occasion (e.g. every time the LSI lot is changed), not limited to fixed values that are determined in advance.

In addition, the number of the assembly unit in the apparatus production unit in both of the first and second embodiments is 1. However, a plurality of assembly units are also possible. Likewise, a plurality of conversion units and LSI production units are possible.

Further, both of the first and second embodiments have a structure of including a conversion unit, an assembly unit, and a LSI production unit in the apparatus production unit. However, the invention is not limited to this structure. For example, in case that an assembly company for the apparatuses is independent from a LSI production company, it is possible to include a conversion unit and a LSI production unit in the LSI production company. And this LSI production company sends encrypted unique information and cryptographic LSI to the assembly company, which in turn writes the encrypted unique information to a nonvolatile memory, and puts together the nonvolatile memory, the cryptographic LSI, and the like.

In such a case, since the encrypted unique information does not have to be sent from the LSI production company confidentially. This enables the assembly company to perform assembly without setting up a special environment in which confidentiality is to be kept. Also in such a case, there may be a plurality of LSI production companies and assembly companies.

Note that the nonvolatile memory used in the first and second embodiments is not limited to a so-called ROM, and may include hard logic, print pattern, or fuse, that is not volatile as a data storage.

Although the present invention has been fully described by way of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A method of producing a decryption apparatus that performs decryption using a decryption key, comprising:
an acquiring step for confidentially acquiring the decryption key under a security-controlled condition;
a conversion information outputting step for generating conversion information, under the security-controlled condition, that includes an encrypted decryption key generated by encrypting the decryption key using an encryption method, and for outputting the generated conversion information;
a writing step for writing the outputted conversion information to a nonvolatile memory which is to be incorporated in the decryption apparatus; and
an assembling step for assembling the decryption apparatus to incorporate therein an integrated device, the integrated device including a first circuit and a second circuit, the first circuit decrypting the encrypted decryption key using a decryption method that corresponds to the encryption method, and the second circuit performing decryption using the decryption key.

2. The production method of claim 1,
wherein the writing step is executed under another condition where a lower level of security is retained than the security-controlled condition.

3. The production method of claim 1,
wherein the encryption method is a secret key cryptographic method that is executed using a secret key,
and the conversion information outputting step encrypts the decryption key using a secret key that has a fixed value.

4. The production method of claim 1,
the conversion information outputting step including:
a selection substep for selecting the encryption method from a plurality of encryption methods;
a selection information generating substep for generating selection information that identifies the encryption method which has been selected at the selection substep;
an encryption substep for encrypting the decryption key using the encryption method to generate the encrypted decryption key; and
a conversion information generating substep for generating the conversion information that includes the encrypted decryption key and the selection information,
wherein the integrated device further includes a third circuit that identifies the encryption method according to the selection information.

5. The production method of claim 4,
wherein the encryption method is a secret key cryptographic method that is executed using a secret key,
the selection substep selects the secret key from a plurality of secret keys,
the selection information generating substep generates the selection information that identifies the secret key which has been selected at the selection substep,
the encryption substep encrypts the decryption key using the secret key to generate the encrypted decryption key,
the conversion information generating substep generates the conversion information that includes the encrypted decryption key generated at the encryption substep and the selection information that identifies the secret key, and
the third circuit identifies the secret key according to the selection information.

6. The production method of claim 5,
the conversion information outputting step further including a key generating substep for generating the plurality of secret keys,
wherein the selection substep selects the secret key from the plurality of secret keys that have been generated at the key generating substep.

7. The production method of claim 1,
wherein the acquiring step acquires the decryption key that is unique to the decryption apparatus.

8. A providing system including an information providing apparatus that provides information to be incorporated in the decryption apparatus, and an integrated-device providing apparatus that provides an integrated device to be incorporated in the decryption apparatus,
the information providing apparatus being placed under a security-controlled condition and comprising:
acquiring means for confidentially acquiring a decryption key which is used in the decryption apparatus for performing decryption; and
conversion information outputting means for generating conversion information that includes an encrypted decryption key generated by encrypting the acquired decryption key using an encryption method, and for outputting the generated conversion information to an assembly unit, the assembly unit being to assemble the decryption apparatus,
and the integrated-device providing apparatus comprising:
producing means for producing an integrated device that includes a first circuit and a second circuit, the first circuit decrypting the encrypted decryption key using a decryption method that corresponds to the encryption method, and the second circuit performing decryption using the decryption key; and
integrated-device providing means for providing the assembly unit with the integrated device produced by the producing means.

9. The providing system of claim 8,
wherein the encryption method is a secret key cryptographic method that is executed using a secret key,
and the conversion information outputting means encrypts the decryption key using a secret key that has a fixed value.

10. The providing system of claim 8,
the conversion information outputting means including:
selection means for selecting the encryption method from a plurality of encryption methods;
selection information generating means for generating selection information that identifies the encryption method which has been selected at the selection means;
encryption means for encrypting the decryption key using the encryption method to generate the encrypted decryption key; and
conversion information generating means for generating the conversion information that includes the encrypted decryption key and the selection information,
wherein the integrated device further includes a third circuit that identifies the encryption method according to the selection information.

11. The providing system of claim 10,
wherein the encryption method is a secret key cryptographic method that is executed using a secret key,
the selection means selects the secret key from a plurality of secret keys,
the selection information generating means generates the selection information that identifies the secret key which has been selected by the selection means,
the encryption means encrypts the decryption key using the secret key to generate the encrypted decryption key,
the conversion information generating means generates the conversion information that includes the encrypted decryption key generated by the encryption means and the selection information that identifies the secret key, and
the third circuit identifies the secret key according to the selection information.

12. The providing system of claim 11,
the conversion information outputting means further including key generating means for generating the plurality of secret keys,
wherein the selection means selects the secret key from the plurality of secret keys that have been generated by the key generating means.

13. The providing system of claim 8,
wherein the acquiring means acquires the decryption key that is unique to the decryption apparatus.

14. A decryption apparatus that performs decryption using a decryption key, including:
a nonvolatile memory that stores conversion information that includes encrypted decryption key generated by encrypting the decryption key using an encryption method; and
an integrated device that includes a first circuit and a second circuit, the first circuit decrypting the encrypted decryption key using a decryption method that corresponds to the encryption method, and the second circuit performing decryption using the decryption key.

15. The decryption apparatus of claim 14,
wherein the encryption method is a secret key cryptographic method that is executed using a secret key,
the nonvolatile memory stores the conversion information that includes encrypted decryption key generated by encrypting the decryption key using a secret key that has a fixed value,
and the integrated device includes the first circuit which decrypts the encrypted decryption key using the secret key that has the fixed value.

16. The decryption apparatus of claim 14,
wherein the encryption method is selected from a plurality of encryption methods,
the nonvolatile memory stores the conversion information that includes selection information identifying the selected encryption method and the encrypted decryption key;
and the integrated device further includes a third circuit that identifies the encryption method according to the selection information.

17. The decryption apparatus of claim 16,
wherein the encryption method is a secret key cryptographic method that is executed using a secret key, the secret key being selected from a plurality of secret keys,
the nonvolatile memory stores the conversion information that includes the selection information identifying the selected secret key and the encrypted decryption key,
and the integrated device includes the third circuit that identifies the secret key according to the selection information.

18. The decryption apparatus of claim 14,
wherein the nonvolatile memory stores thereon the conversion information that includes the encrypted decryption key generated by encrypting, using the encryption method, the decryption key which is unique to the decryption apparatus.
